(19) United States
(12) Patent Application Publication
(10) Pub. No.: US 2002/0128905 A1
(43) Pub. Date: Sep. 12, 2002

(54) System and method for networking

(76) Inventors: Roger Gillman, New York, NY (US); David C. Weiss, Baldwin, NY (US)

Correspondence Address: WEISS & WEISS, SUITE 305, 500 OLD COUNTRY ROAD, GARDEN CITY, NY, 11530, US

(21) Appl. No.: 09/801,167

(22) Filed: Mar. 7, 2001

(51) Int. Cl. G06F 17/60

(52) U.S. Cl. 705/14

(57) ABSTRACT

The present invention relates to a system and method for networking with persons online.

### FIELD OF THE INVENTION

The present invention relates to a system and method for networking with persons online.

### BACKGROUND OF THE INVENTION

Presently, there exists several large in-person networking organizations. The members attend these meetings in person, usually weekly and take a lot of time in their busy days between traveling to the meetings and attending the meetings.

Members join these networking groups for business leads and referral sources, which are provided on a regular basis by members of the group to each other. Members of networking groups refer themselves, their relatives, their friends, their coworkers and others to other people in their networking group to do business.

### SUMMARY OF THE INVENTION

The present invention provides an online forum for professionals, salespeople and business owners and others to build professional relationships. The networking meetings can be regularly scheduled, daily, weekly, or monthly. The system of the present invention provides a forum for individuals to build their businesses and/or professional practices, of almost any type, by gaining long-lasting referral sources and business leads.

The present invention allows a user to attend networking meetings at their convenience from an office, at home, or on vacation. This will increase attendance at such meetings and the benefits to all involved.

It is an object of the present invention to allow users to attend group chat rooms and send private messages to other members in their networking group. It is an object of the present invention to provide live video feeds allowing individuals in a group to see each other.

It is an object of the present invention to provide networking groups wherein professionals and businessmen are placed in a group so as not to compete in business with other professionals in the same networking group. For example, two doctors who are both orthopedic surgeons who work in the same area of a city, who may compete with each other for business, will not be placed in the same networking group.

It is an object of the present invention to provide networking groups on a local, city, state, country and international level.

It is an object of the present invention to provide networking groups consisting solely of lawyers or other professionals, wherein the lawyers in each networking group do not compete with each other.

It is an object of the present invention to provide rewards or incentives to those members of a networking group who provide the most referrals to those in their networking group.

It is an object of the present invention to provide a means for providing a point system relating to the number of referrals each member in a networking group gives to another member.

It is an object of the present invention to remove members from a networking group who do not provide referrals to other members in the networking group, or meet a minimum number of referrals.

It is an object of the present invention for each potential member to provide a resume concerning the type of business they do, and in what areas of the country they do business. The present invention uses this information to select the appropriate networking group for each individual.

### DETAILED DESCRIPTION OF PREFERRED EMBODIMENTS

In a preferred embodiment, networking groups are organized so that no two professions directly overlap. For example, only one stock or mortgage broker in a given location is allowed into a group. However, there might be one real estate attorney, one personal injury attorney, and one tax attorney in the same networking group with different types of small business owners and brokers.

If a person is unable to enter a desired group, due to lack of available space, a new group is automatically created in the desired locale by the system of the present invention. In this way, there is always an opening for new members available in their preferred locations.

Users are able to choose the location of their networking group. For instance, certain companies may just be doing business in a local area and therefore, may request their local town or city. Other companies may request to have other members from around the state, country or around the world be members of their networking group.

Members of each group are be able to communicate in a group chat-room during scheduled meetings or send private messages to each other during, before, or after regularly scheduled online group meetings. In a further embodiment, the system of the present invention has video and audio conferencing capabilities to the members and communities.

Members can register online. Members can view which networking groups have openings in their area. The system of the present invention allows users to view profiles of the members within a particular networking group to see if they would be interested in joining a particular group. In a preferred embodiment, profiles can include, but are not limited to: names, phone numbers, email addresses, physical addresses, profession/industry, territory of business, revenues, and number of employees. Individuals and businesses, at their option and discretion, can post and edit information about themselves on their own personal computers, as they deem appropriate.

The system of the present invention provides networking groups within a town or local community, state to state and country to country.

In a preferred embodiment incentives are given to the persons within a networking group who give out the most qualified referrals.

In a preferred embodiment, the present invention provides networking groups consisting solely of lawyers or other professionals, wherein the lawyers in each networking group do not compete with each other. For example, a networking group of lawyers can consist of specialty lawyers, such as a corporate lawyer, personal injury lawyer, patent lawyer, real estate lawyer. All of these lawyers can be from the same area or multiple areas in the country. Since lawyers are only allowed to practice in areas of the country in which they are licensed, lawyers of the same specialty can be in a networking group from different states in the United States or from different countries. For example, a networking group can consist of patent lawyers from N.Y., Ohio, Fla., and Calif.

In one embodiment, the present invention provides a point system relating to the number of referrals each member in a networking group gives to another member. In a preferred embodiment, the system of the present invention has an email or Internet inbox which provides information to others within the networking group regarding whether a referral from a member in their networking group led to a client, and whether the referral was a true referral, meaning the person who was referred expected a communication from the person in the networking group. In a preferred embodiment, an email or Internet inbox can be provided which provides comments as to how the person in the networking group dealt with the referral.

In one embodiment of the present invention, the system removes members from a networking group who do not provide referrals to other members in the networking group, or meet a minimum number of referrals.

### EXAMPLE 1

The following is an example of a local networking group of the present invention.

Personal Injury Attorney

Beautician

Dentist

Software Engineer

Mortgage Broker

Corporate Attorney

Medical Supply Salesman

Stock Broker

Electrician

Party Planner

Office Supply Manager

Temporary Agency Manager

Investment Banker

The members of the local networking group can provide referrals to each person within their group. If an investment banker tried to enter this group, the system of the present invention directs this person to another networking group because there is already another investment banker in this group. Local networking groups such as shown in Example 1 could then plan Internet networking sessions with networking groups from other states where members from certain networking groups could seek referrals. For example, a personal injury attorney from New York who is licensed to practice in New York could seek referrals from a personal injury attorney from Ohio who is solely licensed to practice law in Ohio. The same could be true from a salesman whose territory is limited to New England who could seek referrals from salesman who are selling products in the Southeast.

1. A method for providing online networking groups comprising;
entering a profile into a computer database;
entering a second profile into said computer database;
comparing said profile and said second profile;
moving said second profile into a second database if said profile and said second profile contain same professions and same areas of practice
creating a networking group containing said computer database;
creating a networking group containing said second database.

2. The method of claim 1 further comprising;
providing referrals between members in said networking group.

3. The method of claim 2 further comprising;
providing rewards or incentives to said members of said networking group who provide most referrals in said networking group.

4. The method of claim 2 further comprising;
providing a point system relating to number of said referrals each member in said networking group gives to another member.

5. The method of claim 2 further comprising;
removing members from said networking group who do not provide referrals to other members in said networking group, or meet a minimum number of referrals.

6. The method of claim 2 further comprising;
communicating with said members via video or audio conferencing.

7. The method of claim 1 wherein said profiles comprise:
name, address, contact information, profession and territory.

8. A system for providing online networking comprising;
a computer database;
said database storing profiles of users;
said system comparing said profiles and creating networking groups.
